(19) United States
(12) Patent Application Publication
(10) Pub. No.: US 2024/0347263 A1
(43) Pub. Date: Oct. 17, 2024

(54) MAGNETIC ELEMENT, INDUCTOR, INDUCTOR ASSEMBLY, AND ELECTRONIC DEVICE

(71) Applicant: HUAWEI DIGITAL POWER TECHNOLOGIES CO., LTD., Shenzhen (CN)

(72) Inventors: Yunyu TANG, Shanghai (CN); Weixin FANG, Shenzhen (CN); Chao LIU, Shanghai (CN); Lei SHI, Shanghai (CN)

(21) Appl. No.: 18/750,996

(22) Filed: Jun. 21, 2024

Related U.S. Application Data
(63) Continuation of application No. PCT/CN2022/139972, filed on Dec. 19, 2022.

(30) Foreign Application Priority Data
Dec. 24, 2021 (CN) 202111604918.3

(51) Int. Cl. H01F 27/30; H01F 27/02; H01F 27/24

(52) U.S. Cl. CPC H01F 27/306; H01F 27/02; H01F 27/24

(57) ABSTRACT

Embodiments of this application provide a magnetic element, an inductor, an inductor assembly, and an electronic device. The magnetic element includes a top plate, a bottom plate, a side plate, and a winding structure. The top plate and the bottom plate are disposed opposite to each other at an interval in a first direction. The winding structure is connected between the top plate and the bottom plate, and is configured to wind a winding. The side plate and the winding structure are disposed at an interval in a second direction. The side plate, the top plate, the winding structure, and the bottom plate jointly form a carrier of a magnetic flux loop. The side plate includes a plurality of strip structures that are stacked. A stacking direction of the plurality of strip structures is a third direction.

### CROSS-REFERENCE TO RELATED APPLICATIONS

This application is a continuation of International Application No. PCT/CN2022/139972, filed on Dec. 19, 2022, which claims priority to Chinese Patent Application No. 202111604918.3, filed on Dec. 24, 2021. The disclosures of the aforementioned applications are hereby incorporated by reference in their entireties.

### TECHNICAL FIELD

This application relates to a magnetic element, an inductor, an inductor assembly, and an electronic device.

### BACKGROUND

With the development of modern science, various electronic and electrical devices ensure high efficiency of social production, and bring great convenience to people's daily life. In addition, electromagnetic interference and radiation generated during working processes of the electronic and electrical devices affect people's life and production, and cause deterioration of an electromagnetic environment in human living space. An inductor has a filtering function when used in an electronic device, and may filter an electromagnetic interference signal and suppress external radiation and emission of an electromagnetic wave generated by a high-speed signal line. How to design an inductor whose size and costs can be controlled and whose magnetic flux can be increased is a research direction in the industry.

### SUMMARY

Embodiments of this application provide a magnetic element, an inductor, an inductor assembly, and an electronic device.

According to a first aspect, an embodiment of this application provides a magnetic element, including a top plate, a bottom plate, a side plate, and a winding structure. The top plate and the bottom plate are disposed opposite to each other at an interval in a first direction. The winding structure is connected between the top plate and the bottom plate, and is configured to wind a winding. The side plate and the winding structure are disposed at an interval in a second direction. The side plate, the top plate, the winding structure, and the bottom plate jointly form a carrier of a magnetic flux loop. The side plate includes a plurality of strip structures that are stacked. A stacking direction of the plurality of strip structures is a third direction. The first direction, the second direction, and the third direction are perpendicular to each other. In this solution, the plurality of strip structures that are stacked form the side plate, and the stacking direction of the strip structures is the third direction. A magnetic flux on the side plate may pass through all the strip structures from the top plate to the bottom plate. The side plate can form a part of the magnetic flux loop, and all the plurality of strip structures can participate in forming the magnetic flux loop, so that a magnetic flux of the magnetic element can be increased.

In a possible implementation, on the magnetic flux loop, all the strip structures are disposed in parallel on a same section of the magnetic flux loop. In this solution, each of the plurality of strip structures that are stacked is disposed to extend from the top plate to the bottom plate. In this way, all the strip structures on the magnetic flux loop are disposed in parallel on the same section of the magnetic flux loop. Therefore, the overall magnetic flux of the magnetic element may be increased.

In a possible implementation, a magnetic flux direction formed by the magnetic flux loop on each strip structure is the first direction. In this solution, all the plurality of strip structures are planar, for example, rectangular structures, and may be directly stacked, adhered, and press-fitted without considering conditions such as whether the strip structure is inclined, whether an inclined plane is formed, or whether the strip structure bends an angle. Therefore, manufacturing difficulty is low, and structure reliability is high.

In a possible implementation, at least a part of a magnetic flux direction formed by the magnetic flux loop on each strip structure is at an included angle to the first direction. In this solution, the plurality of strips may be planar structures, but are inclined relative to the first direction in an assembly process. In this way, on the magnetic flux loop, a magnetic circuit flows from the top plate to the bottom plate along the inclined strip structures. Compared with the solution in which the magnetic flux direction is the first direction in the foregoing implementation, in this application, a length of the magnetic circuit may be increased, an inductance may be adjusted, and a parameter of the magnetic flux loop and performance of an inductor may be adjusted, so that the inductor can meet a use requirement.

In an implementation, each strip structure has a bent section. It may be understood as that the strip structure in this solution is a non-flat structure. With the design of the strip structure with the bent section, a length of a magnetic circuit may be increased, an inductance may be adjusted, and a parameter of the magnetic flux loop and performance of an inductor may be adjusted, so that the inductor can meet a use requirement. Specifically, the strip structure includes a first section, a second section, and a third section that are sequentially connected. The first section bends and extends relative to the second section. The third section also bends and extends relative to the second section. In this implementation, the first section and the third section may be symmetrically arranged on two sides of the second section. In the magnetic element, a plane in which the second section is located may be a direction parallel to a reference plane formed by the first direction and the second direction. The first section and the third section are inclined relative to the reference plane. In this implementation, the first section and the third section are disposed, so that a length of the magnetic flux loop may be increased, and performance of the magnetic element may be improved. It may be understood as that there may be a plurality of bent sections on the strip structure, and the bent section may be in a planar form or a cambered form.

In a possible implementation, an outer edge of each strip structure forms a part of an outer surface of the side plate. It may be understood as that no protective layer may be disposed on an outer surface of the strip structure, and the strip structure does not need to be wrapped. Because a periphery of the side plate does not need to be wound with a coil, in this implementation of this application, a strip may be exposed on an outer surface of the magnetic element. Therefore, each strip can better participate in the magnetic flux loop, which helps increase the magnetic flux of the magnetic element.

In a possible implementation, the top plate is an integrated structure. The bottom plate is a split structure. An outer surface of the side plate includes a top surface and a bottom surface that are disposed opposite to each other, and a side surface connected between the top surface and the bottom surface. A winding space is formed between the side surface and the winding structure. The top surface is fixedly connected to a surface, facing the bottom plate, of the top plate. The side surface includes a fastening surface. The fastening surface is fixedly connected to the bottom plate. In this embodiment of this application, the bottom plate is designed as a multi-sectional (split) structure. In a process of assembling the side plate, the top plate, and the bottom plate, the top surface of the side plate is first fastened to a first inner surface of the top plate, and the winding structure is fastened to the first inner surface of the top plate. Then, the bottom plate is fastened to the winding structure through adhesive between a second inner surface of the bottom plate and an end face of the winding structure. Then, a bottom side surface of the bottom plate is fastened to the fastening surface of the side plate. This solution has a low requirement on size precision of the side plate, and a size of the side plate in the first direction does not need to be strictly controlled, so that machining costs are reduced, and assembly efficiency may be improved. If the side plate is slightly long in the first direction due to a manufacturing tolerance, an assembly error, or the like, after the bottom side surface is connected to the fastening surface of the side plate, the side plate may protrude relative to a second outer surface of the bottom plate, that is, the second outer surface of the bottom plate is concave relative to the bottom surface of the side plate. If the side plate is slightly short in the first direction, a part of the bottom side surface of the bottom plate is fixedly connected to the fastening surface of the side plate, the bottom surface of the side plate is concave relative to the bottom plate, and a part of the bottom side surface of the bottom plate is exposed instead of being connected to the fastening surface. In an implementation, there are two or more winding structures and bottom plates that are disposed in a one-to-one correspondence. All the bottom plates may be coplanar, that is, all the bottom plates are equal in thickness. All second inner surfaces are coplanar. All second outer surfaces are also coplanar. This solution requires that sizes of all the winding structures are equal in the first direction. In another implementation, sizes of all the winding structures are not equal in the first direction, and all the bottom plates are designed to be non-coplanar. In this solution, with the non-coplanar design of the bottom plates, the bottom plates may match winding structures of different sizes, and requirements for manufacturing precision of the winding structures are different, so that manufacturing costs may be reduced.

In an implementation, there are a plurality of side plates of the magnetic element, and sizes of the plurality of side plates in the first direction are different. With the disposed sectional bottom plate, a size error of the side plate in the first direction may be absorbed in an assembly process, and an assembly problem that the sizes of the plurality of winding structures in the first direction are different may be further resolved. This provides convenience for the assembly process of the magnetic element.

In a possible implementation, a first groove is disposed on a surface, away from the bottom plate, of the top plate. The first groove and the winding structure are disposed opposite to each other in the first direction. The winding structure includes a central axis. The central axis passes through the first groove. In this solution, the first groove is disposed at a position that is on an outer surface of the top plate and that is directly opposite to a central region of the winding structure, that is, a part of a material of the top plate is removed. In this way, a magnetic flux distribution advantage of the magnetic element is used, thereby saving a magnetic core material and reducing a weight and costs of the magnetic element without affecting an inductance.

In a possible implementation, a length direction of the first groove is the third direction. A width direction of the first groove is the second direction. A depth direction of the first groove is the first direction. In the width direction of the first groove, the first groove is symmetrically distributed by using the central axis as a center. In this solution, the first groove is disposed by using the central axis of the winding structure as the center, that is, the central axis of the winding structure and a central line of the first groove are collinear. According to this solution, convenience is provided for a design process of the first groove, and there is a reference to ensure that the first groove is disposed without affecting magnetic flux distribution of the magnetic element.

In a possible implementation, in the third direction, the first groove passes through two oppositely disposed side surfaces of the top plate. It may be understood as that the first groove is open on a first outer surface and the side surfaces connected to two sides of the first outer surface. The first groove is disposed to pass through the two opposite side surfaces of the top plate, so that not only is the first groove large enough, but also fit between the first groove and a housing of an inductor assembly is facilitated.

In a possible implementation, a width of the first groove is less than or equal to half of a width of the winding structure. A width direction of the winding structure is the second direction. In this solution, an upper limit of the width of the first groove is limited, so that a size of the first groove does not affect magnetic flux distribution of the magnetic element. If the width of the first groove exceeds half of the width of the winding structure, magnetic flux distribution on the top plate may be affected. If the width of the first groove is half of the width of the winding structure, a material and a weight of the top plate may be reduced more effectively.

In a possible implementation, a second groove is disposed on a surface, away from the top plate, of the bottom plate. The second groove and the winding structure are disposed opposite to each other in the first direction. The central axis of the winding structure passes through the second groove. In this solution, an advantage of disposing the second groove on the bottom plate is the same as that of disposing the first groove on the top plate, and both are saving materials and reducing weights. The second groove and the first groove are symmetrically distributed on two sides of a winding post in the first direction. Such a symmetrically distributed architecture makes a structure of the magnetic element symmetric.

In a possible implementation, there are N winding structures. There are (N+1) side plates. In the second direction, the (N+1) side plates are disposed at intervals, and the N winding structures are disposed between two adjacent side plates in a one-to-one correspondence.

In a possible implementation, the magnetic element is configured to form a two-phase inductor, or the magnetic element is configured to form a three-phase inductor.

According to a second aspect, an embodiment of this application provides an inductor, including a winding and the magnetic element according to any possible implementation of the first aspect. The winding is wound around the winding structure.

According to a third aspect, an embodiment of this application provides an inductor assembly, including a housing and the inductor according to the second aspect. The housing is provided with an accommodating space. The accommodating space has an opening position. The inductor is installed in the accommodating space from the opening position.

According to a fourth aspect, an embodiment of this application provides an electronic device, including a control circuit and the inductor according to the second aspect. The inductor is electrically connected to the control circuit.

According to a fifth aspect, an embodiment of this application provides an inductor assembly, including a housing, a winding, and the magnetic element according to the first aspect. The winding is wound around the winding structure. The housing includes a fastening portion. The fastening portion is accommodated in the first groove. The fastening portion is configured to be fixedly connected to an electronic device.

In this application, the first groove is disposed on the top plate of the magnetic element, and the second groove is disposed on the bottom plate. The first groove and the second groove are disposed without affecting magnetic flux distribution. In addition, positions of the first groove and the second groove are further used to accommodate the fastening portion of the housing of the inductor assembly. The fastening portion is fastened to an electronic device through a screw. In this way, the housing of the inductor assembly may be small, which is conducive to a miniaturized and lightweight design of the inductor assembly.

According to a sixth aspect, an embodiment of this application provides an electronic device, including a fastening plate, a control circuit, and the inductor assembly according to the fifth aspect. The fastening portion of the housing is fixedly connected to the fastening plate. The winding is electrically connected to the control circuit.

In a possible implementation, the fastening plate is a housing of the electronic device. A heat dissipation structure is disposed on an outer surface of the housing of the inductor assembly. The control circuit is disposed on a circuit board inside the housing. The winding passes through the housing, and is electrically connected to the circuit board.

### BRIEF DESCRIPTION OF DRAWINGS

To describe the technical solutions in embodiments of this application more clearly, the following describes the accompanying drawings for describing embodiments of this application or the background.

FIG. 1 is a schematic three-dimensional diagram of a magnetic element according to an implementation of this application;

FIG. 2 is a schematic sectional view of a magnetic element according to an implementation of this application;

FIG. 3 is a schematic diagram of a plurality of strip structures of a side plate in a magnetic element according to an implementation of this application;

FIG. 4 is a schematic three-dimensional diagram of a side plate in a magnetic element according to an implementation of this application;

FIG. 5 is a side view of a side plate in a magnetic element according to an implementation of this application, where a direction of an arrow represents a magnetic flux direction on the side plate;

FIG. 6 is a schematic diagram of one strip structure of a side plate in a magnetic element according to an implementation of this application;

FIG. 7 is a side view of the strip structure shown in FIG. 6, where a direction of an arrow represents a magnetic flux direction on the side plate;

FIG. 8 is a schematic diagram of magnetic flux distribution of a magnetic element according to an implementation of this application;

FIG. 9 is a schematic diagram of an inductor according to an implementation of this application;

FIG. 10 is a schematic three-dimensional exploded view of an inductor assembly according to an implementation of this application;

FIG. 11 is a schematic three-dimensional assembly diagram of an inductor assembly according to an implementation of this application;

FIG. 12 is a schematic plan view of an inductor assembly according to an implementation of this application;

FIG. 13 is a schematic sectional view of the inductor assembly shown in FIG. 12 in an A-A direction;

FIG. 14 is a schematic diagram of an electronic device according to an implementation of this application;

FIG. 15 is a schematic sectional view of an electronic device according to an implementation of this application;

FIG. 16 is a diagram of a circuit architecture of an electronic device according to an implementation of this application; and

FIG. 17 is a schematic three-dimensional diagram of a magnetic element according to an implementation of this application.

### DESCRIPTION OF EMBODIMENTS

The following describes embodiments of this application with reference to the accompanying drawings in the embodiments of this application.

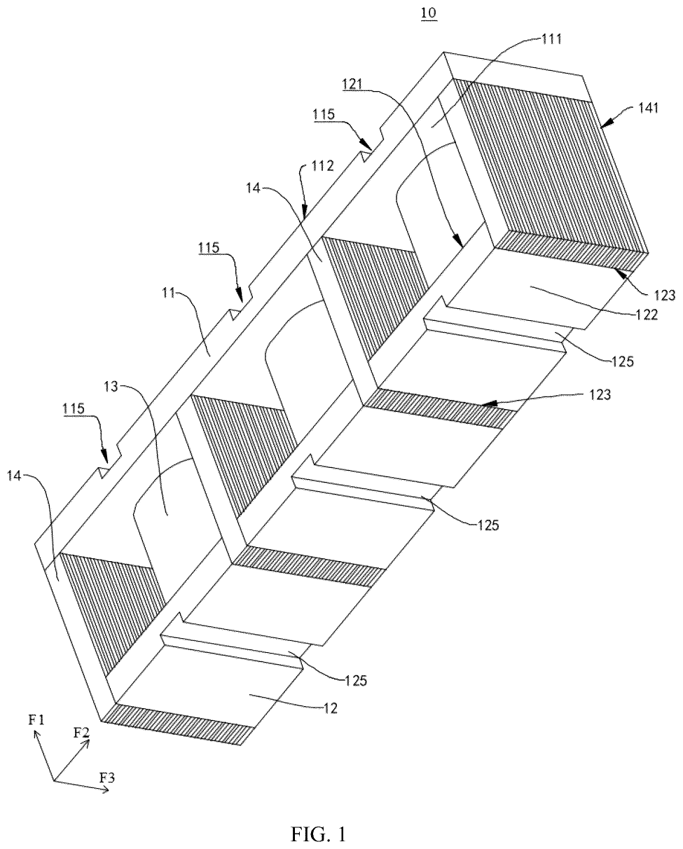

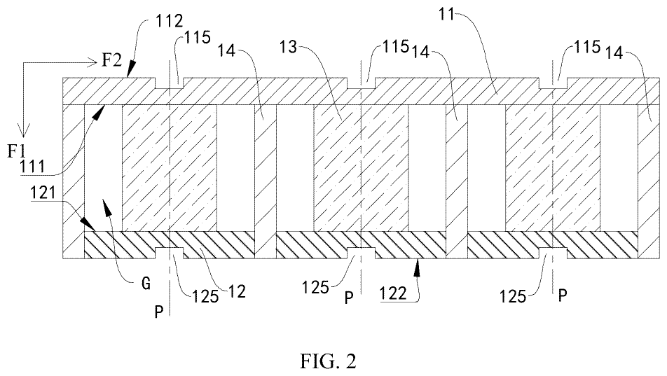

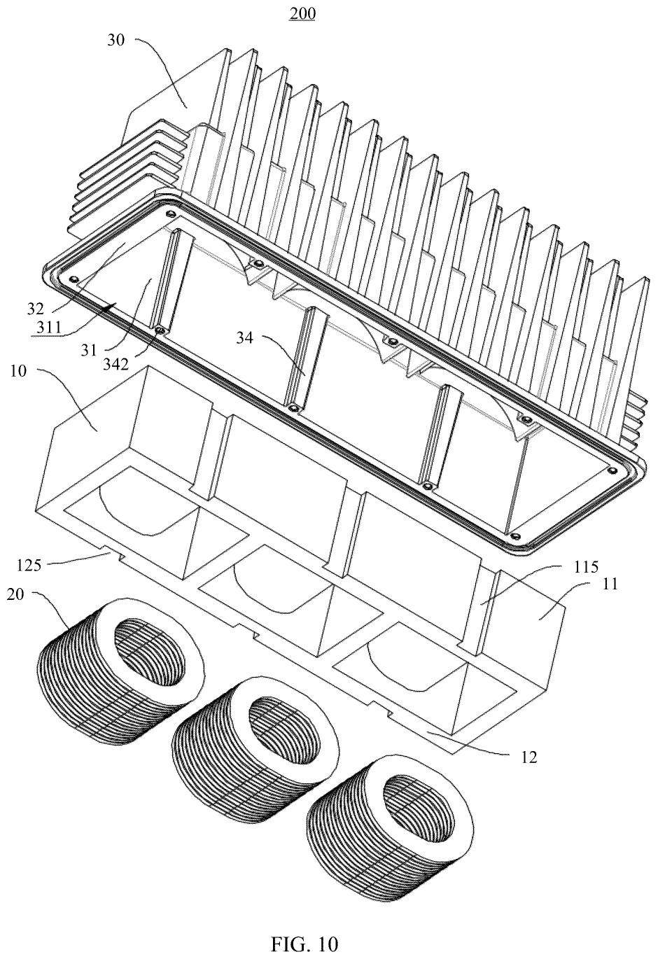

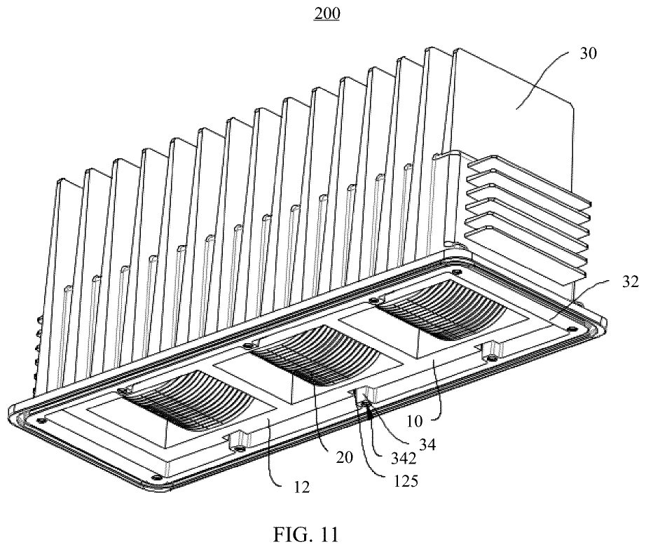

Refer to FIG. 1 and FIG. 2. A magnetic element 10 provided in a specific implementation of this application is a magnetic core. The magnetic element 10 includes a top plate 11, a bottom plate 12, winding structures 13, and side plates 14. The top plate 11 and the bottom plate 12 are disposed opposite to each other at an interval in a first direction F1. A space between the top plate 11 and the bottom plate 12 is used to accommodate the side plates 14 and the winding structures 13. The winding structure 13 is connected between the top plate 11 and the bottom plate 12, and is configured to wind a winding. The side plates 14 and the winding structures 13 are arranged at intervals in a second direction F2. The second direction F2 is perpendicular to the first direction F1. The side plates 14, the top plate 11, the winding structures 13, and the bottom plate 12 jointly form a carrier of a magnetic flux loop (FIG. 9 schematically shows an architecture of the magnetic flux loop, and in FIG. 9, a dashed box represents the magnetic flux loop, and an arrow on the dashed box represents a magnetic flux direction). There are N winding structures 13. There are (N+1) side plates 14. In the second direction F2, the (N+1) side plates 14 are disposed at intervals, and the N winding structures 13 are disposed between two adjacent side plates 14 in a one-to-one correspondence. When the magnetic element 10 is configured to form a two-phase inductor, N is 2, three side plates 14 arranged at intervals are disposed between the top plate 11 and the bottom plate 12, the side plates 14, the top plate 11, and the bottom plate 12 jointly form two winding spaces G, and two winding structures 13 are respectively disposed in the two winding spaces G. When the magnetic element 10 is configured to form a three-phase inductor, N is 3, four side plates 14 arranged at intervals are disposed between the top plate 11 and the bottom plate 12, the side plates 14, the top plate 11, and the bottom plate 12 jointly form three winding spaces G, and three winding structures 13 are respectively disposed in the three winding spaces G.

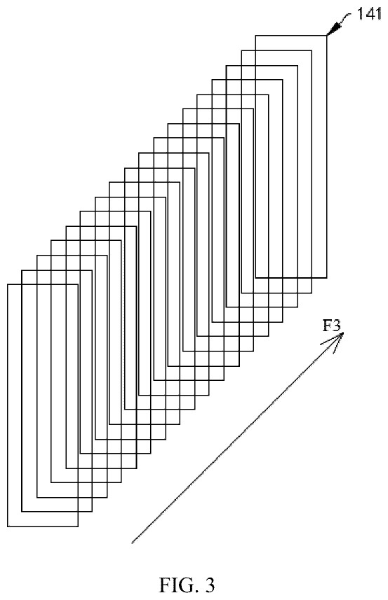

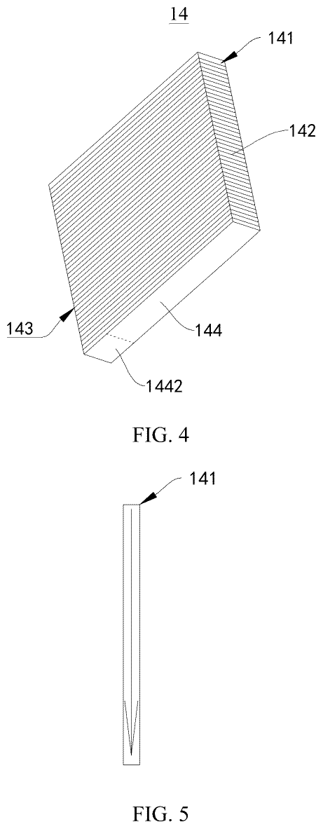

Refer to FIG. 1, FIG. 3, and FIG. 4. For each side plate 14, the side plate 14 includes a plurality of strip structures 141 that are stacked. A stacking direction of the plurality of strip structures 141 is a third direction F3. The first direction F1, the second direction F2, and the third direction F3 are perpendicular to each other. FIG. 1 schematically shows a stacking arrangement of the plurality of strip structures 141 in the second direction F2. In an actual product, two adjacent strip structures 141 are connected through an adhesive layer. If the stacking direction of the plurality of strip structures 141 that are stacked is the second direction F2, on the magnetic flux loop of the magnetic element 10, only a strip structure 141 close to the winding can participate in forming the magnetic flux loop, which affects distribution of a magnetic flux of the magnetic element 10. If the stacking direction of the plurality of strip structures 141 that are stacked is the first direction F1, on a magnetic circuit between the top plate 11 and the bottom plate 12, adjacent strip structures 141 are fastened through adhesive. Because of existence of the adhesive layer, the magnetic circuit is interrupted, and the magnetic flux loop cannot be formed. In this solution, the plurality of strip structures 141 that are stacked form the side plate 14, and the stacking direction of the strip structures 141 is the third direction F3. A magnetic flux on the side plate 14 may pass through all the strip structures 141 from the top plate 11 to the bottom plate 12. The side plate 14 can form a part of the magnetic flux loop, and all the plurality of strip structures 141 can participate in forming the magnetic flux loop, so that the magnetic flux of the magnetic element 10 can be increased.

The strip structure 141 is a magnetic core material with a characteristic of high magnetic permeability, for example, an amorphous or nanocrystalline strip. The winding structure 13 may also be a magnetic column architecture formed by using a strip, for example, formed by winding an amorphous or nanocrystalline strip. However, if the winding structure 13 is formed by using the strip, a protective layer needs to be disposed on an outer surface of the strip. This is because the winding needs to be wound outside the winding structure 13. If no protective layer is disposed outside the strip, pulling force directly acts on the strip in a winding process of the winding, which may damage the strip and affect the magnetic flux. In another implementation, the winding structure 13 may alternatively be a magnetic column structure formed through die casting, for example, made of a ferrite material. The winding structure 13 may be integrated with the top plate 11. For example, the top plate and the winding structure are integrated in a die casting manner. A magnetic element manufactured in this manner is more stable.

A section of the winding structure 13 is a circle or an ellipse, and an outer circumferential surface of the winding structure 13 may be a cambered surface, so that winding is facilitated. A section of the side plate 14 is rectangular, so that convenience is provided for an adhesion and manufacturing process of the strip structure 141. The section is parallel to a plane formed by the second direction and the third direction. The section is perpendicular to the first direction.

Refer to FIG. 4 and FIG. 5. Specifically, the plurality of strip structures 141 are stacked, and adjacent strip structures 141 are adhered, to form the side plate 14. Each strip structure 141 is a sheet-like body or a surface-like body. In an implementation, the strip structure 141 is planar. The plane formed by the first direction F1 and the second direction F2 is a reference plane. A plane formed by each strip structure 141 is parallel to the reference plane. As shown in FIG. 5, in this solution, a magnetic flux direction formed on the strip structure 141 is the first direction F1. In this solution, all the plurality of strip structures 141 are planar, for example, rectangular structures, and may be directly stacked, adhered, and press-fitted without considering conditions such as whether the strip structure is inclined, whether an inclined plane is formed, or whether the strip structure bends an angle. Therefore, manufacturing difficulty is low, and structure reliability is high.

In another implementation, a plane formed by each strip structure 141 may alternatively be at an included angle to the reference plane. It may be understood as that each strip structure 141 is inclined relative to the reference plane. In this solution, a magnetic flux direction formed on the strip structure 141 is also at an included angle to the first direction F1. In this implementation, the strip structure 141 is inclined, so that a length of the magnetic flux loop can be increased. Specifically, in this solution, the plurality of strips may alternatively be planar structures, but are inclined relative to the first direction F1 in an assembly process. In this way, on the magnetic flux loop, the magnetic circuit flows from the top plate 11 to the bottom plate 12 along the inclined strip structures 141. Compared with the solution in which the magnetic flux direction is the first direction F1 in the foregoing implementation, in this application, a length of the magnetic circuit may be increased, an inductance may be adjusted, and a parameter of the magnetic flux loop and performance of an inductor may be adjusted, so that the inductor can meet a use requirement.

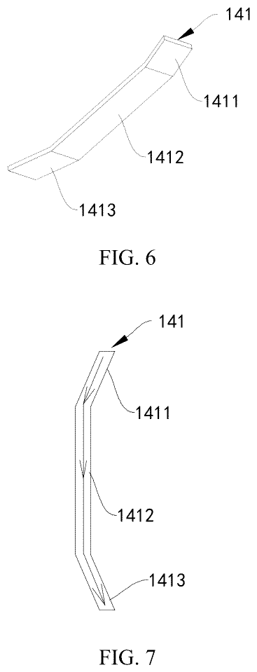

In another implementation, each strip structure 141 is a non-plat structure, that is, the strip structure 141 has a bent section. As shown in FIG. 6, the strip structure 141 includes a first section 1411, a second section 1412, and a third section 1413 that are sequentially connected. The first section 1411 bends and extends relative to the second section 1412. The third section 1413 also bends and extends relative to the second section 1412. In this implementation, the first section 1411 and the third section 1413 may be symmetrically arranged on two sides of the second section 1412. In the magnetic element 10, a plane in which the second section 1412 is located may be parallel to a reference plane formed by the first direction F1 and the second direction F2. The first section 1411 and the third section 1413 are inclined relative to the reference plane. As shown in FIG. 7, a magnetic flux direction on the strip structure 141 with the bent section includes three different directions. Compared with the implementation shown in FIG. 5, in this implementation, the first section 1411 and the third section 1413 are disposed, so that a length of the magnetic flux loop may be increased, an inductance may be adjusted, and a parameter of the magnetic flux loop and performance of an inductor may be adjusted, so that the inductor can meet a use requirement. It may be understood as that there may be a plurality of bent sections on the strip structure 141, and the bent section may be in a planar form or a cambered form. This is not limited in this application.

According to this embodiment of this application, the plurality of strip structures 141 are stacked, and each strip structure 141 extends from the top plate 11 to the bottom plate 12. In this way, all the strip structures 141 on the magnetic flux loop are disposed in parallel on a same section of the magnetic flux loop. Therefore, the overall magnetic flux of the magnetic element 10 may be increased.

For the side plate 14, no protective layer may be disposed on an outer surface of the strip structure 141, and the strip structure 141 does not need to be wrapped. That is, an outer edge of each strip structure 141 forms a part of an outer surface of the side plate 14. Because a periphery of the side plate 14 does not need to be wound with a coil, in this implementation of this application, a strip may be exposed on an outer surface of the magnetic element 10. Therefore, each strip can better participate in the magnetic flux loop, which helps increase the magnetic flux of the magnetic element 10.

Refer to FIG. 1 and FIG. 4. In an implementation, an outer surface of the side plate 14 includes a top surface 142 and a bottom surface 143 that are disposed opposite to each other, and a side surface 144 connected between the top surface 142 and the bottom surface 143. A winding space is formed between the side surface 144 and the winding structure 13. The side surface 144 includes a fastening surface 1442 (a dashed line on the side surface 144 in FIG. 4 is used to separate the fastening surface 1442). The fastening surface 1442 is adjacent to the bottom surface 143. Alternatively, the fastening surface 1442 is close to the bottom surface 143 (the fastening surface 1442 and the bottom surface 143 are separated by a part of the side surface 144). The top plate 11 includes a first inner surface 111 and a first outer surface 112. The first inner surface 111 is a surface, facing the bottom plate 12, of the top plate 11. The first outer surface 112 is a surface, away from the bottom plate 12, of the top plate 11. The bottom plate 12 includes a second inner surface 121, a second outer surface 122, and a bottom side surface 123 connected between the second inner surface 121 and the second outer surface 122. The second inner surface 121 is a surface, facing the top plate 11, of the bottom plate 12. The second outer surface 122 is a surface, away from the top plate 11, of the bottom plate 12.

In an implementation, the top plate 11 is an integrated structure, and the bottom plate 12 is a split structure. For example, when the magnetic element 10 provided in this application is used in the two-phase inductor, the top plate 11 is a flat structure, the bottom plate 12 is two flat structures independent of each other, there are three side plates 14, there are two winding structures 13, and the bottom plate 12 is connected between two adjacent side plates 14. When the magnetic element 10 provided in this application is used in the three-phase inductor, there are three bottom plates 12 and three winding structures 13, there are four side plates 14, and similarly, the bottom plates 12 are also connected between two adjacent side plates 14. Specifically, the top surface 142 of the side plate 14 is fixedly connected to the first inner surface 111 of the top plate 11, and the fastening surface 1442 is fixedly connected to the bottom plate 12. In an implementation, the second outer surface 122 of the bottom plate 12 is coplanar with the bottom surface 143 of the side plate 14, or protrudes relative to the bottom surface 143 of the side plate 14. In another implementation, the second outer surface 122 of the bottom plate 12 is not coplanar with the bottom surface 143 of the side plate 14, and the second outer surface 122 of the bottom plate 12 is concave relative to the bottom surface 143 of the side plate 14. Two end faces of the winding structure 13 are respectively connected to the first inner surface 111 and the second inner surface 121. An outer circumferential surface of the winding structure 13 is used to wind the winding. The outer circumferential surface of the winding structure 13 is disposed opposite to a part of the side surface 144 of the side plate 14.

In this application, the top plate 11 is designed as the integrated structure. The top plate 11 is used as a base for assembling another part of the magnetic element 10. Therefore, stability and reliability of an overall structure of the magnetic element 10 can be improved.

In this embodiment of this application, the bottom plate 12 is designed as a multi-sectional (split) structure. In a process of assembling the side plate 14, the top plate 11, and the bottom plate 12, the top surface 142 of the side plate 14 is first fastened to the first inner surface 111 of the top plate 11, and the winding structure 13 is fastened to the first inner surface 111 of the top plate 11. Then, the bottom plate 12 is fastened to the winding structure 13 through adhesive between the second inner surface 121 of the bottom plate 12 and the end face of the winding structure 13. Then, the bottom side surface 123 of the bottom plate 12 is fastened to the fastening surface 1442 of the side plate 14. This solution has a low requirement on size precision of the side plate 14, and a size of the side plate 14 in the first direction F1 does not need to be strictly controlled, so that machining costs are reduced, and assembly efficiency may be improved. If the side plate 14 is slightly long in the first direction F1 due to a manufacturing tolerance, an assembly error, or the like, after the bottom side surface 123 is connected to the fastening surface 1442 of the side plate 14, the side plate 14 may protrude relative to the second outer surface 122 of the bottom plate 12, that is, the second outer surface 122 of the bottom plate 12 is concave relative to the bottom surface 143 of the side plate 14. If the side plate 14 is slightly short in the first direction F1, a part of the bottom side surface 123 of the bottom plate 12 is fixedly connected to the fastening surface of the side plate 14, the bottom surface 143 of the side plate 14 is concave relative to the bottom plate 12, and a part of the bottom side surface 123 at the bottom is exposed instead of being connected to the fastening surface 1442. In an implementation, there are two or more winding structures 13 and bottom plates 12 that are disposed in a one-to-one correspondence. All the bottom plates 12 may be coplanar, that is, all the bottom plates 12 are equal in thickness. All second inner surfaces 121 are coplanar. All second outer surfaces 122 are also coplanar. This solution requires that sizes of all the winding structures 13 are equal in the first direction F1. In another implementation, sizes of all the winding structures 13 are not equal in the first direction F1, and all the bottom plates 12 are designed to be non-coplanar. In this solution, with the non-coplanar design of the bottom plates 12, the bottom plates 12 may match winding structures 13 of different sizes, and requirements for manufacturing precision of the winding structures 13 are different, so that manufacturing costs may be reduced.

In an implementation, there are a plurality of side plates 14 of the magnetic element 10, and sizes of the plurality of side plates 14 in the first direction F1 are different. With the disposed sectional bottom plate 12, a size error of the side plate 14 in the first direction F1 may be absorbed in an assembly process, and an assembly problem that the sizes of the plurality of winding structures 13 in the first direction F1 are different may be further resolved. This provides convenience for the assembly process of the magnetic element 10.

In another implementation, the top plate 11 and the bottom plate 12 each may be an integrated structure. In this solution, the top surface 142 of the side plate 14 is connected to the top plate 11, and the bottom surface 143 of the side plate 14 is connected to the bottom plate 12. In this solution, machining precision of the side plate 14 needs to be ensured, and sizes of the plurality of side plates 14 in the first direction F1 are controlled within a proper tolerance range. This solution helps improve overall strength and reliability of the magnetic element 10. In addition, it is easy to connect the bottom plate 12 to the side plate 14.

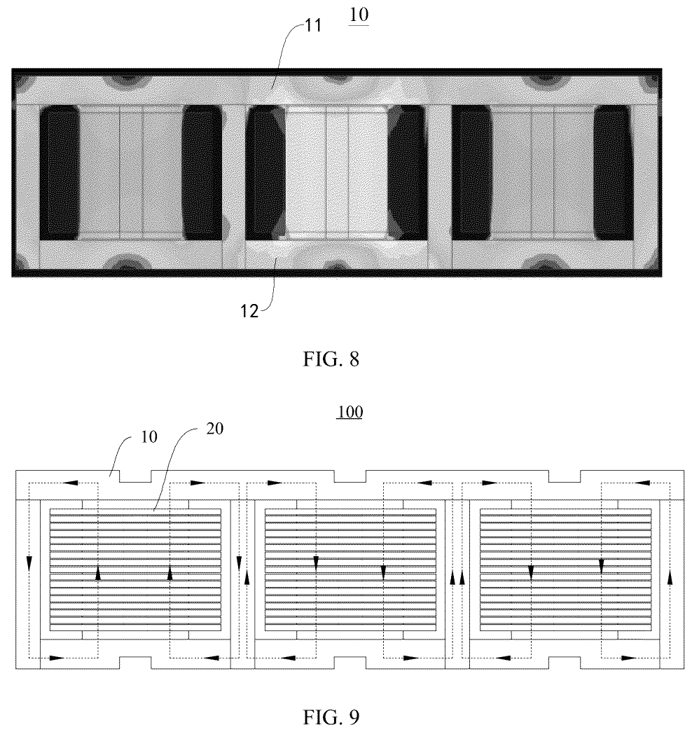

In an implementation, refer to FIG. 1 and FIG. 2. First grooves 115 are disposed on the first outer surface 112 of the top plate 11. The first groove 115 and the winding structure 13 are disposed opposite to each other in the first direction F1. A central axis P of the winding structure 13 passes through the first groove 115. In this solution, the first groove 115 is disposed at a position that is on the first outer surface 112 of the top plate 11 and that is directly opposite to a central region of the winding structure 13, that is, a part of a material of the top plate 11 is removed. In this way, a magnetic flux distribution advantage of the magnetic element 10 is used, thereby saving a magnetic core material and reducing a weight and costs of the magnetic element 10 without affecting an inductance. Refer to FIG. 8. The magnetic element 10 is used in an inductor. It is found by analyzing magnetic flux distribution on the top plate 11 that there is almost no magnetic flux distribution at a position that is on the top plate 11 and that is directly opposite to the central region of the winding structure 13. For example, in FIG. 8, dark regions at positions that are on the top plate 11 and the bottom plate 12 and that correspond to the winding structure 13 are regions without magnetic flux distribution. Therefore, in this application, disposing the first groove 115 at this position can reduce the weight. In addition, the first groove 115 may be configured to fit with a housing of an inductor assembly, and content of this part will be described in detail below.

In an implementation, a length direction of the first groove 115 is the third direction F3. A width direction of the first groove 115 is the second direction F2. A depth direction of the first groove 115 is the first direction F1. In the width direction of the first groove 115, the first groove 115 is symmetrically distributed by using the central axis P of the winding structure 13 as a center. In this solution, the first groove 115 is disposed by using the central axis P of the winding structure 13 as the center, that is, the central axis P of the winding structure 13 and a central line of the first groove 115 are collinear. According to this solution, convenience is provided for a design process of the first groove 115, and there is a reference to ensure that the first groove 115 is disposed without affecting magnetic flux distribution of the magnetic element 10.

In a specific implementation, a width of the first groove 115 is less than or equal to half of a width of the winding structure 13. A width direction of the winding structure 13 is the second direction F2. In this solution, an upper limit of the width of the first groove 115 is limited, so that a size of the first groove 115 does not affect magnetic flux distribution of the magnetic element 10. If the width of the first groove 115 exceeds half of the width of the winding structure 13, magnetic flux distribution on the top plate 11 may be affected. If the width of the first groove 115 is half of the width of the winding structure 13, a material and a weight of the top plate 11 may be reduced more effectively.

A quantity of the first grooves 115 is the same as that of the winding structures 13. The first grooves 115 are distributed at intervals on the first outer surface 112 of the top plate 11 along the second direction F2. In the third direction F3, the first groove 115 passes through two opposite side surfaces 144 of the top plate 11. It may be understood as that the first groove 115 is open on the first outer surface 112 and the side surfaces 144 connected to two sides of the first outer surface 112. The first groove 115 is disposed to pass through the two opposite side surfaces 144 of the top plate 11, not only is the first groove 115 large enough, but also fit between the first groove 115 and the housing of the inductor assembly is facilitated. Content of this part will be described in detail below.

In an implementation, second grooves 125 are disposed on the second outer surface 122 of the bottom plate 12. The second groove 125 and the winding structure 13 are disposed opposite to each other in the first direction F1. The central axis P of the winding structure 13 passes through the second groove 125. In this solution, an advantage of disposing the second groove 125 on the bottom plate 12 is the same as that of disposing the first groove 115 on the top plate 11, and both are saving materials and reducing weights. The second groove 125 and the first groove 115 are symmetrically distributed on the two sides of the winding structure 13 in the first direction F1. Such a symmetrically distributed architecture makes a structure of the magnetic element 10 symmetric. A structure form and a size of the second groove 125 may be the same as those of the first groove 115, and details are not described again.

Refer to FIG. 9. An embodiment of this application provides an inductor 100. In FIG. 9, a dashed box with an arrow represents a magnetic flux loop on the inductor 100. The inductor 100 includes a magnetic element 10 and a winding 20. The winding 20 is wound around a winding structure 13 of the magnetic element 10. FIG. 9 shows a structure of a three-phase inductor. The inductor 100 provided in this application may alternatively be a two-phase inductor. In another implementation, the inductor 100 provided in this application may alternatively be an inductor 100 integrating at least two two-phase inductors, an inductor 100 integrating at least two three-phase inductors, or an inductor 100 integrating a two-phase inductor and a three-phase inductor. A user may combine the inductor based on a specific requirement.

Refer to FIG. 10 and FIG. 11. An embodiment of this application provides an inductor assembly 200, including a housing 30 and an inductor 100. The housing 30 is provided with an accommodating space 31. The accommodating space 31 has an opening position 311. The inductor 100 is installed in the accommodating space 31 from the opening position 311. The housing 30 is configured to cover the inductor 100, to protect the inductor 100 and dissipate heat of the inductor 100. In addition, the housing 30 further has a function of installing and fastening the inductor 100. In a specific implementation, the housing 30 is an aluminum housing. The housing 30 may be manufactured as an integrated stamped structure. The inductor 100 is fastened in the accommodating space 31 inside the housing 30. The housing 30 is configured to be fixedly connected to a fastening plate (for example, a housing or another fastening structure) of an electronic device, to fasten the inductor 100.

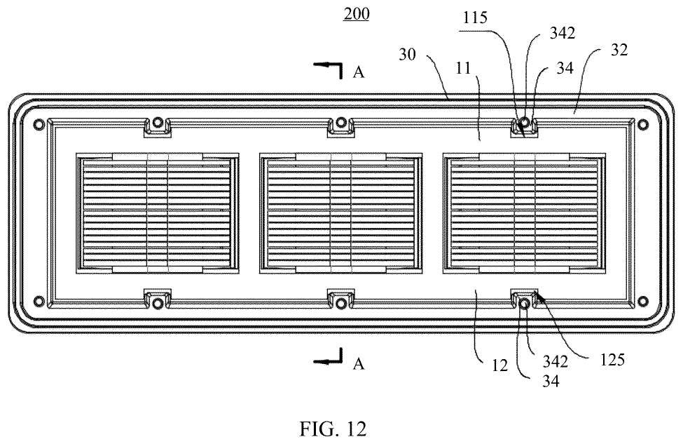

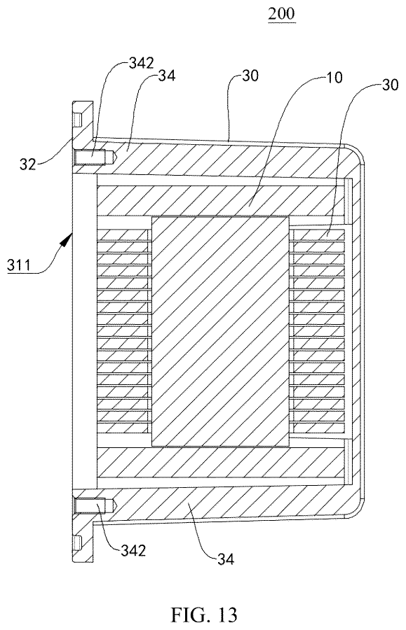

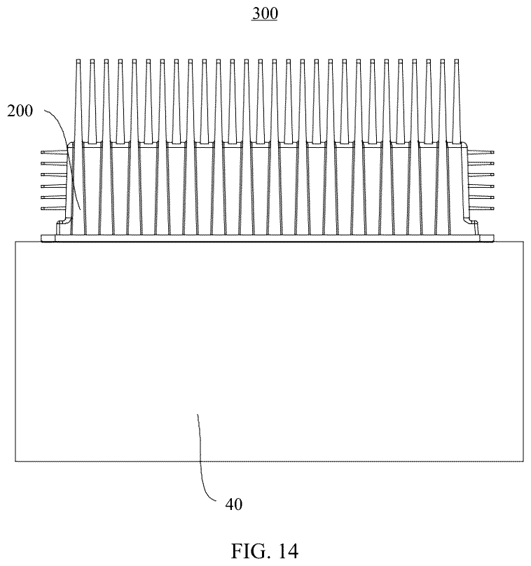

Refer to FIG. 12 and FIG. 13. The housing 30 includes an open end 32. The open end 32 is provided with the opening position 311 that connects the accommodating space 31 to the outside of the housing 30. The inductor 100 is installed in the accommodating space 31 from the opening position 311. Specifically, fastening portions 34 protrude from an inner wall of the housing 30. The fastening portion 34 is strip-shaped. The fastening portion 34 extends from the opening position 311 to a bottom of the accommodating space 31. The bottom of the accommodating space 31 is a part of the housing 30 disposed opposite to the opening position 311. The fastening portions 34 are disposed in a one-to-one correspondence with first grooves 115 and second grooves 125. An outer profile of the fastening portion 34 is smaller than an internal space of the first groove 115 and the second groove 125, to facilitate installation. In an implementation, in this application, the fastening portion 34 fits with the first groove 115 and the second groove 125 of the inductor 100, to install the inductor 100 inside the housing 30. Specifically, before installation, an opening of the first groove 115 of the inductor 100 on a side surface of a top plate 11 and an opening of the second groove 125 on a side surface of a bottom plate are first aligned with the fastening portions 34. In this way, the fastening portion 34 is equivalent to a slide rail, and the inductor 100 slides into the accommodating space 31 along the fastening portion 34. The fastening portion 34 is provided with a fastening hole 342. The fastening hole 342 is disposed at the open end 32 of the housing 30. The fastening hole 342 may be a screw hole, and is configured to fit with a screw, to install the inductor assembly 200 on the fastening plate of the electronic device.

In this application, the first groove 115 is disposed on the top plate 11 of the magnetic element 10, and the second groove 125 is disposed on the bottom plate 12. The first groove 115 and the second groove 125 are disposed without affecting magnetic flux distribution. In addition, positions of the first groove 115 and the second groove 125 are further used to accommodate the fastening portions 34 of the housing 30 of the inductor assembly 200. The fastening portion 34 is fastened to the electronic device through the screw. In this way, the housing 30 of the inductor assembly 200 may be small, which is conducive to a miniaturized and lightweight design of the inductor assembly 200.

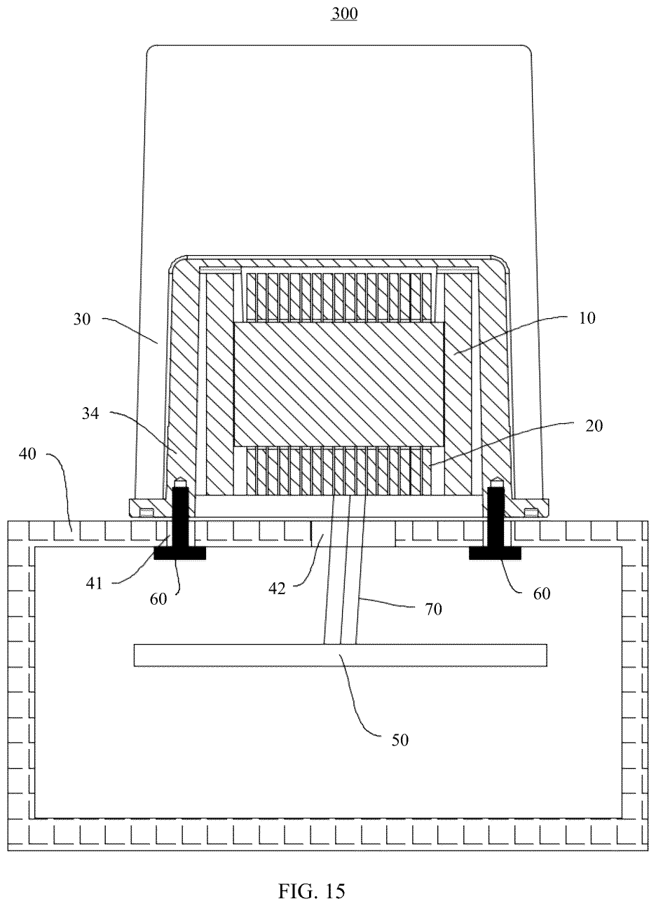

Refer to FIG. 14 and FIG. 15. An embodiment of this application provides an electronic device 300. The electronic device 300 may be a power device such as an inverter. Alternatively, the electronic device may be a computer, a router, another communication device, a terminal device, or the like. A specific type of the electronic device is not specifically limited in this embodiment of this application. The electronic device 300 needs to be a device with a magnetic element 10. Specifically, a switch-mode power circuit is disposed in the electronic device. The magnetic element 10 provided in this application may be disposed in the switch-mode power circuit to filter a common-mode electromagnetic interference signal. The electronic device 300 includes a fastening plate 40, a control circuit 50, and an inductor assembly 200. Fastening portions 34 of a housing 30 of the inductor assembly 200 are fixedly connected to the fastening plate 40. A winding 20 is electrically connected to the control circuit 50. Specifically, the fastening plate 40 of the electronic device 300 is a housing of the electronic device. A plurality of mounting holes 41 are disposed on the fastening plate 40. The mounting holes 41 are disposed in a one-to-one correspondence with the fastening portions 34 of the inductor assembly 200. A via 42 is further disposed on the fastening plate 40. The plurality of mounting holes 41 are disposed around the via 42. The via 42 is configured to dispose an electrical connection structure 70. The electrical connection structure 70 may be a wire electrically connected between the winding 20 of an inductor 100 and the control circuit 50 in the electronic device 300. The control circuit 50 is disposed on a circuit board inside the electronic device 300.

In an assembly process, first, an open end 32 of the housing 30 of the inductor assembly 200 faces the fastening plate 40 of the electronic device 300. A fastening hole 342 on the fastening portion 34 of the housing 30 of the inductor assembly 200 is aligned with the mounting hole 41 on the fastening plate 40. The electrical connection structure 70 connected to the winding 20 passes through the via 42 on the fastening plate 40, and is electrically connected to the control circuit 50. Then, a fastener 60 (for example, a screw) extends into the mounting hole 41 from a side, away from the inductor assembly 200, of the fastening plate 40, and is locked in the fastening hole 342. FIG. 14 and FIG. 15 merely schematically represent the housing and the internal control circuit of the electronic device, and are not intended to limit a specific structure of the electronic device.

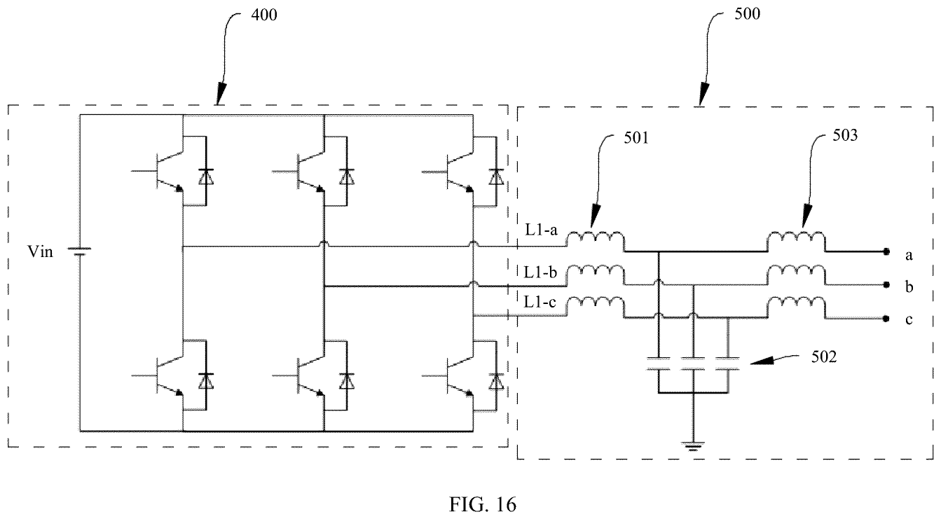

FIG. 16 is a diagram of a circuit architecture when the electronic device is an inverter. The inverter includes a three-phase inverter circuit 400 and an LCL circuit 500. The LCL circuit 500 includes a first inductor 501, a capacitor 502, and a second inductor 503 that are sequentially connected in series. The first inductor 501 is an inverter inductor. In an implementation, the inductor assembly 200 provided in this application may be the first inductor 501 in the circuit architecture shown in FIG. 16.

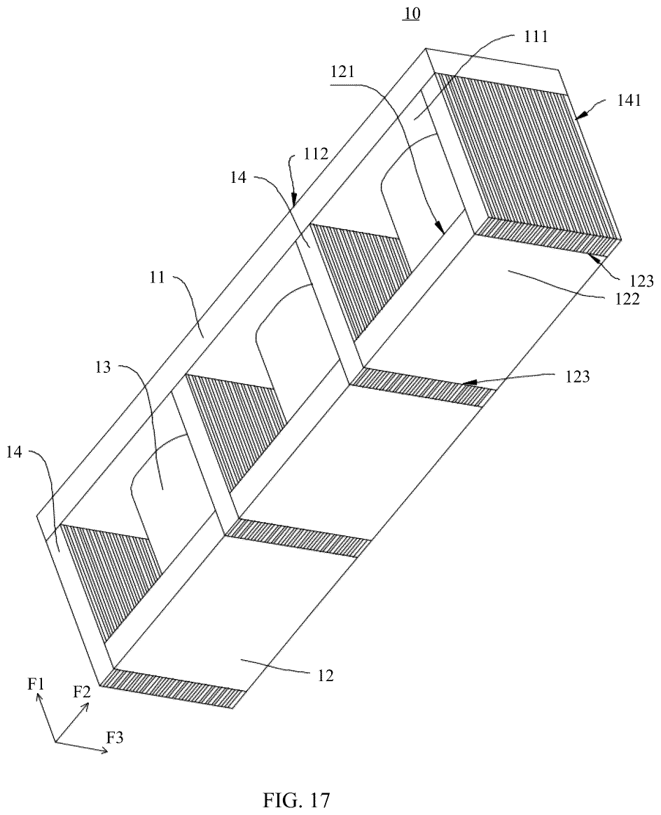

FIG. 17 is a three-dimensional schematic diagram of the magnetic element according to an implementation of this application. Compared with FIG. 1, in the implementation shown in FIG. 17, no groove structure is disposed on the top plate 11, and no groove structure is disposed on the bottom plate 12. That is, an outer surface of the bottom plate 12 and an outer surface of the top plate 11 are both planar.

First, second, third, fourth, and various numbers in this specification are used merely for distinguishing for ease of description, and are not intended to limit the scope of this application.

It should be understood that, in embodiments of this application, sequence numbers of the foregoing processes do not mean execution sequences. The execution sequences of the processes should be determined according to functions and internal logic of the processes, and should not be construed as any limitation on implementation processes of embodiments of this application.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1. A magnetic element, comprising
a top plate,
a bottom plate,
a side plate,
and a winding structure,
wherein the top plate and the bottom plate are disposed opposite to each other at an interval in a first direction; the winding structure is connected between the top plate and the bottom plate, and is configured to wind a winding; the side plate and the winding structure are disposed at an interval in a second direction; the side plate, the top plate, the winding structure, and the bottom plate jointly form a carrier of a magnetic flux loop; the side plate comprises a plurality of strip structures that are stacked; a stacking direction of the plurality of strip structures is a third direction; and the first direction, the second direction, and the third direction are perpendicular to each other.

2. The magnetic element according to claim 1, wherein on the magnetic flux loop, the plurality of strip structures are disposed in parallel on a same section of the magnetic flux loop.

3. The magnetic element according to claim 2, wherein a magnetic flux direction formed by the magnetic flux loop on each strip structure is the first direction, or a magnetic flux direction formed by the magnetic flux loop on each strip structure is at an included angle to the first direction.

4. The magnetic element according to claim 1, wherein an outer edge of each strip structure forms a part of an outer surface of the side plate.

5. The magnetic element according to claim 1, wherein the top plate is an integrated structure, and the bottom plate is a split structure; an outer surface of the side plate comprises a top surface and a bottom surface that are disposed opposite to each other, and a side surface connected between the top surface and the bottom surface; and a winding space is formed between the side surface and the winding structure, the top surface is fixedly connected to a surface, facing the bottom plate, of the top plate, the side surface comprises a fastening surface, and the fastening surface is fixedly connected to the bottom plate.

6. The magnetic element according to claim 1, wherein a first groove is disposed on a surface, away from the bottom plate, of the top plate, the first groove and the winding structure are disposed opposite to each other in the first direction, the winding structure comprises a central axis, and the central axis passes through the first groove.

7. The magnetic element according to claim 6, wherein a length direction of the first groove is the third direction, a width direction of the first groove is the second direction, a depth direction of the first groove is the first direction, and in the width direction of the first groove, the first groove is symmetrically distributed by using the central axis as a center.

8. The magnetic element according to claim 7, wherein in the third direction, the first groove penetrates two oppositely disposed side surfaces of the top plate.

9. The magnetic element according to claim 7, wherein a width of the first groove is less than or equal to half of a width of the winding structure, and a width direction of the winding structure is the second direction.

10. The magnetic element according to claim 6, wherein a second groove is disposed on a surface, away from the top plate, of the bottom plate, the second groove and the winding structure are disposed opposite to each other in the first direction, and the central axis of the winding structure passes through the second groove.

11. The magnetic element according to claim 1, wherein there are N winding structures, and there are (N+1) side plates; and in the second direction, the (N+1) side plates are disposed at intervals, and the N winding structures are disposed between two adjacent side plates in a one-to-one correspondence.

12. The magnetic element of claim 11, wherein the magnetic element is configured to form a two-phase inductor, or the magnetic element is configured to form a three-phase inductor.

13. An inductor assembly, comprising
a housing,
a winding,
and an magnetic element,
and wherein the magnetic element, comprises a top plate, a bottom plate, a side plate, and a winding structure, wherein the top plate and the bottom plate are disposed opposite to each other at an interval in a first direction; the winding structure is connected between the top plate and the bottom plate, and is configured to wind a winding; the side plate and the winding structure are disposed at an interval in a second direction; the side plate, the top plate, the winding structure, and the bottom plate jointly form a carrier of a magnetic flux loop; the side plate comprises a plurality of strip structures that are stacked; a stacking direction of the plurality of strip structures is a third direction; and the first direction, the second direction, and the third direction are perpendicular to each other, and
wherein the winding is wound around the winding structure, the housing comprises a fastening portion, the fastening portion is accommodated in a first groove, and the fastening portion is configured to be fixedly connected to an electronic device.

14. The inductor assembly according to claim 13, wherein on the magnetic flux loop, the plurality of strip structures are disposed in parallel on a same section of the magnetic flux loop.

15. The inductor assembly according to claim 14, wherein a magnetic flux direction formed by the magnetic flux loop on each strip structure is the first direction, or a magnetic flux direction formed by the magnetic flux loop on each strip structure is at an included angle to the first direction.

16. The inductor assembly according to claim 13, wherein an outer edge of each strip structure forms a part of an outer surface of the side plate.

17. An electronic device, comprising
a fastening plate,
a control circuit,
and an inductor assembly,
wherein the inductor assembly, comprising a housing, a winding, and an magnetic element,
and wherein the magnetic element, comprises a top plate, a bottom plate, a side plate, and a winding structure, wherein the top plate and the bottom plate are disposed opposite to each other at an interval in a first direction; the winding structure is connected between the top plate and the bottom plate, and is configured to wind a winding; the side plate and the winding structure are disposed at an interval in a second direction; the side plate, the top plate, the winding structure, and the bottom plate jointly form a carrier of a magnetic flux loop; the side plate comprises a plurality of strip structures that are stacked; a stacking direction of the plurality of strip structures is a third direction; and the first direction, the second direction, and the third direction are perpendicular to each other, and
wherein the winding is wound around the winding structure, the housing comprises a fastening portion, the fastening portion is accommodated in a first groove, and the fastening portion is configured to be fixedly connected to an electronic device, and
wherein the fastening portion of the housing is fixedly connected to the fastening plate, and the winding is electrically connected to the control circuit.

18. The electronic device according to claim 17, wherein the fastening plate is a housing of the electronic device, a heat dissipation structure is disposed on an outer surface of the housing of the inductor assembly, the control circuit is disposed on a circuit board inside the housing, and the winding passes through the housing, and is electrically connected to the circuit board.

19. The electronic device according to claim 17, wherein on the magnetic flux loop, the plurality of strip structures are disposed in parallel on a same section of the magnetic flux loop.

20. The electronic device according to claim 19, wherein a magnetic flux direction formed by the magnetic flux loop on each strip structure is the first direction, or a magnetic flux direction formed by the magnetic flux loop on each strip structure is at an included angle to the first direction.
